(19) United States
(12) Patent Application Publication
(10) Pub. No.: US 2002/0073810 A1
(43) Pub. Date: Jun. 20, 2002

(54) Tool holder for a machine tool

(76) Inventor: L. James Sasanecki, West Suffield, CT (US)

Correspondence Address: Stanton E. Collier, PERMAN & GREEN, LLP, 425 Post Road, Fairfield, CT, 06430, US

(21) Appl. No.: 09/981,205

(22) Filed: Oct. 16, 2001

Related U.S. Application Data
(60) Provisional application No. 60/241,143, filed on Oct. 17, 2000.

(51) Int. Cl. B23B 1/00; B23B 29/00

(52) U.S. Cl. 82/1.11; 82/159

(57) ABSTRACT

A material removal tool holder for a machine tool such as a CNC automatic turret lathe comprises a frame for attachment to a turret with a tool holding channel formed therein for holding a material removal tool. The material removal tool is held within the channel by fasteners connected to the frame. The position of the removal tool within the channel of the frame is adjustable by means of an adjustable shim mounted in the channel. The adjustable shim is disposed in the tool holding channel between the material removal tool and a wall of the channel, and is adjustable to position a cutting edge of the material removal tool to a predetermined position in the machine tool.

### CROSS-REFERENCE TO RELATED APPLICATION

This application claims the benefit of U.S. Provisional Patent Application No. 60/241,143, filed Oct. 17, 2000, which is incorporated by reference herein in its entirety.

### BACKGROUND OF THE INVENTION

### 1. Field of the Invention

The present invention relates to tool holders and, more particularly, to tool holders for mounting material removal tools on machine tools.

### 2. Brief Description of Related Developments

Machining accuracy of a machine tool, such as for example a lathe, is generally dependent on factors such as the precision of machine tool movement, control of the work piece mounted to the machine, positioning of the material removing tools with respect to the area to be machined by the machine tool, and heat build up at the working surface of the material removing tool. Computer numerically controlled (CNC) machine tools, such as for example, the Citizen TM automatic lathes, have gone a long way to overcoming problems with precision of the movement of the machine tool, and control of the work piece on the machine tool. However, problems persist in the prior art in regards to accurate placement of the material removing tools before starting the machining process, and heat buildup during machining. These problems can be sufficiently significant to overcome any advantages provided by employing a CNC machine tool to machine a work piece. For example, inaccurate placement of the tool in the CNC machine tool may cause the CNC machine tool to machine inaccurate dimensions regardless of the high precision of the movements controlled by the computerized controller of the machine tool. In addition, inaccurate placement may result in excessive wear of the tools which could cause premature failure. The present invention overcomes the problems of the prior art especially regarding the precise positioning of material removal tools in the machine tool, and heat buildup at the working surfaces of the material removal tool during machining.

### SUMMARY OF THE INVENTION

The present invention is directed to a material removal tool holder. In one embodiment, the material removal tool holder for a machine tool comprises a frame with a tool holding channel formed therein for holding a material removal tool. The material removal tool is held by fasteners connected to the frame for holding the material removal tool in the tool holding channel of the frame. The position of the material removal tool in the channel of the tool holder may be changed by means of an adjustable shim mounted to the frame, the adjustable shim being disposed in the tool holding channel between the material removal tool and a wall of the channel, and being adjustable to position a cutting edge of the material removal tool to a predetermined position in the machine tool for engagement with a work piece.

In another embodiment, the invention provides a method for removing material from a work piece by a material removal tool held in a tool holder. The method comprises the step of adjusting a position of the material removal tool within a channel of the tool holder to align a cutting edge of the tool with the work piece. An adjustable device is mounted within the tool holder for adjusting the position of the material removal tool.

### BRIEF DESCRIPTION OF THE DRAWINGS

The foregoing aspects and other features of the present invention are explained in the following description, taken in connection with the accompanying drawings, wherein:

FIG. 1 is an exploded perspective view of a tool holder for a machine tool incorporating features of the present invention, and a cutting tool to be mounted to the machine tool with the tool holder;

FIG. 2 is a side plan view of the tool holder in FIG. 1 with the cutting tool mounted therein.

FIG. 3 is a bottom plan view of the tool holder in FIG. 1;

FIG. 4 is a partial plan view of a machine tool with a turret on which the tool holder of FIG. 1 is mounted;

FIG. 5 is a partial side plan view of an adjustable shim with a shim adjusting fastener engaged therein; and

FIG. 6 is a front plan view of a liquid coolant outlet port of the tool holder of FIG. 1.

### DETAILED DESCRIPTION OF THE PREFERRED EMBODIMENT

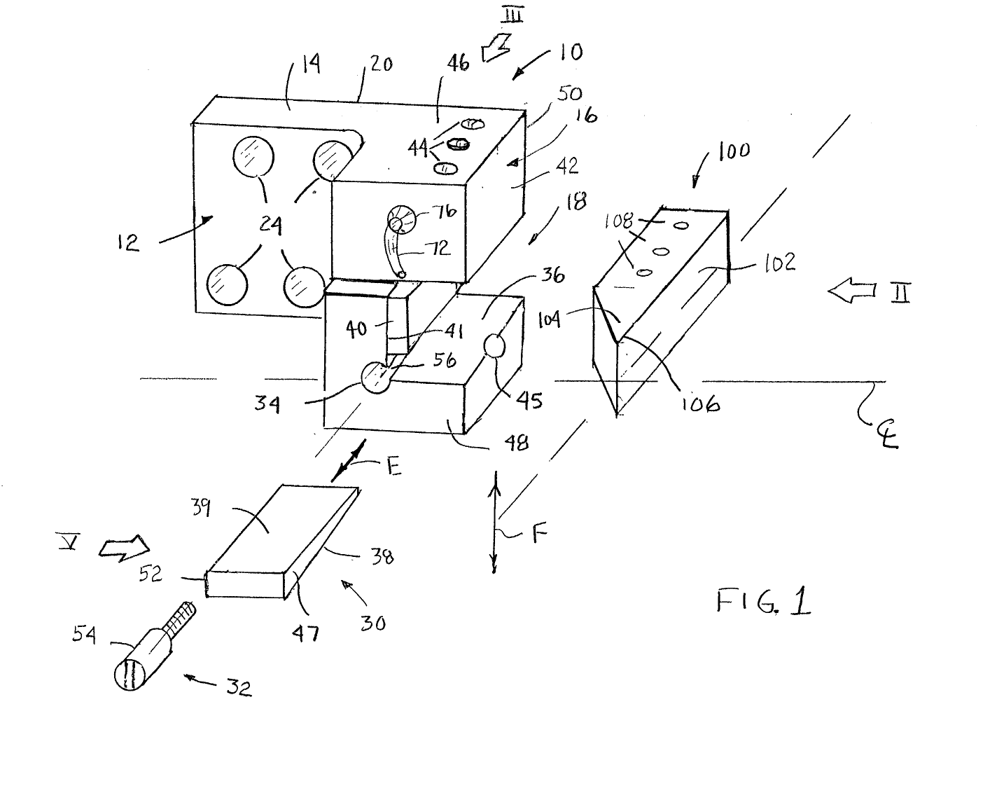

Referring to FIG. 1, there is shown an exploded perspective view of a machine tool holder 10 incorporating features of the present invention, and a material removal or cutting tool 100 is mounted to the tool holder 10. Although the present invention will be described with reference to the single embodiment shown in the drawings, it should be understood that the present invention can be embodied in many alternate forms of embodiments. In addition, any suitable size, shape or type of elements or materials could be used.

The tool holder 10, in FIG. 1, is shown relative to a center line axis CL of a spindle 212, FIG. 4, on a CNC machine tool 216, only partially shown, such as a Citizen TM automatic turret lathe to which tool holder 10 may be mounted as will be described in greater detail below. Although, the present invention will be described in detail with respect to a CNC turret lathe such as the Citizen TM models M220, M32, M12, M16 turret lathes, the present invention applies equally to any other suitable machine tool. In the preferred embodiment, the CNC machine tool may be a vertical or horizontal turret lathe. The machine tool may include one or more spindles to which work pieces are mounted. The centerline axis CL in FIG. 1 represents the centerline of any one of the spindles in the machine tool as desired. Referring to FIG. 4, the spindle 212 rotates a work piece 214, only partially shown, mounted on the spindle 200 to perform various machining operations controlled by a computer controller 210 of the CNC machine tool 216. As the work piece 214 is rotated by the spindle 212, one or more material removal tools are brought into contact with the work piece 214 to effect the desired machining operation. Machining operations may involve, for example, machining outer diameter (OD) features on the work piece, or machining inner diameter (ID) features on the work piece. The tools used to perform the machining may be mounted on turrets, or drums, and gang blocks on one or more cross slides, in the CNC machine tool. The material removal tools may include, for example, cutting tools, forming tools, and drilling tools.

Each material removal tool may be held in a tool holder, such as tool holder 10 in FIG. 1. Cutting tool 100, in FIG. 1, is merely an example of a material removal tool for a turret lathe. In alternate embodiments the material removal tools may have any other suitable shape or form. The tool 100 generally comprises a shank 102 and work section 104. The work section 104 is supported by the shank 102. The work section 104 is provided with one or more cutting edges 106 used for cutting or forming the work piece 214, only partially shown in FIG. 4, which is mounted on the spindle 212 of the machine tool. The shank 102 of the material removal tool 100 is mounted in the tool holder 10. The tool holder 10 is mounted to the turret 200 of the machining tool and the material removal tool 100 is mounted in the tool holder 10.

The tool holder 10, in FIG. 1, is adapted to be mounted to a face of the turret 200 (FIG. 4) of the CNC turret lathe. The tool holder 10 generally comprises a frame 12, with a tool mounting groove or channel 18 therein. The tool 100 is mounted to the tool holder 10 in the tool mounting groove 18. The frame 12 is fastened to a face of the turret and holds the tool 100 in position during machining operations. An adjustable shim 30 is located in the tool mounting channel 18 of the tool holder 10 to adjust the position of the tool 100 with respect to the centerline axis CL of the spindle 212.

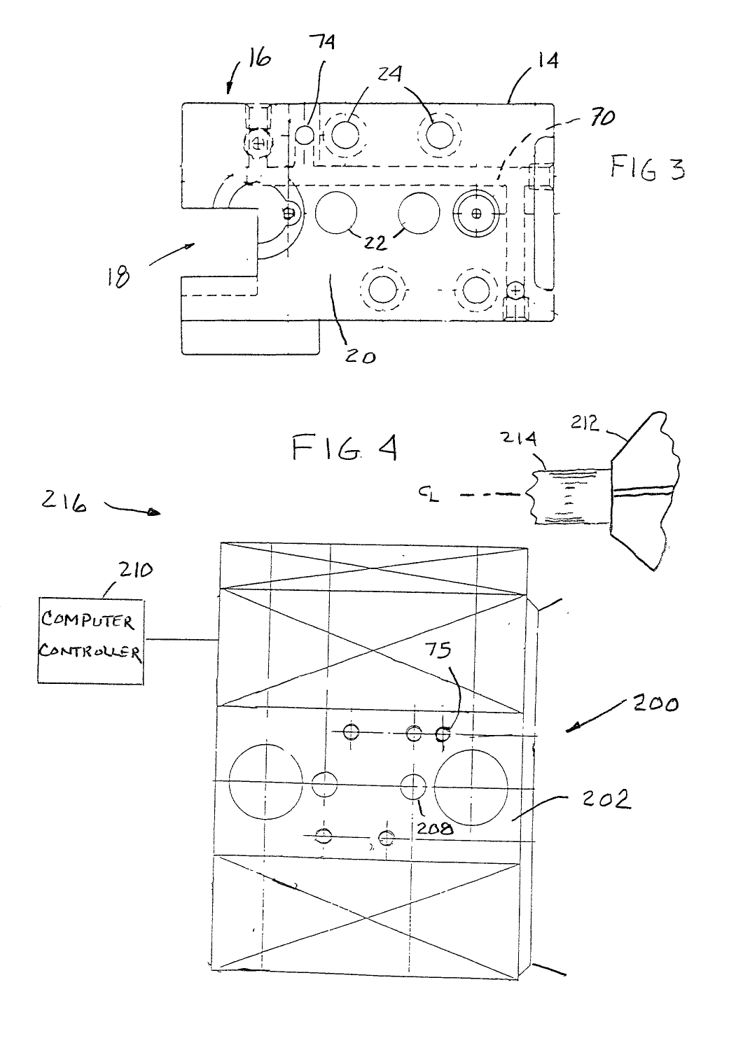

In greater detail, the frame 12 of the tool holder 10 is preferably a one-piece member made from a suitable metal such as steel. In the preferred embodiment, the frame 12 has a general “L” shape which defines a base 14 and a tool mounting block 16 of the tool holder 10. The seating surface 20 of the base 14 is flat, and may be machined to conform to features on a corresponding seating surface of face 202 on the turret 200 (see FIG. 4). For example, the turret face 202 may have one or more locating pins or dowels 208 used to properly align, and prevent shifting of the tool holder 10 on the turret face. Accordingly, as shown in FIG. 3, the seating surface 20 of the base 14 may have fitted holes 22 formed therein for receiving the dowels therein. The base 14 of the holder is also preferably provided with a number of fastener holes 24 (in the preferred embodiment four holes 24 are provided) used for hold down bolts or screws (not shown) for mounting tool holder 10 to the turret face 202.

Tool mounting block 16 has a general block shape with the tool mounting channel 18 formed in the front end 42 of the block 16. The tool mounting channel 18 is sized and shaped generally to admit the shank 102 of tool 100 therein. A number of fastener holes 44 are formed in one side 46 (see FIG. 1). The fastener holes 44 are located to coincide with fastener holes 108 in the shank 102 of the tool 100 when the tool 100 is located in the channel 18. Fasteners may then be inserted through holes 44 and 108 to fasten the tool 100 to the tool holder 10.

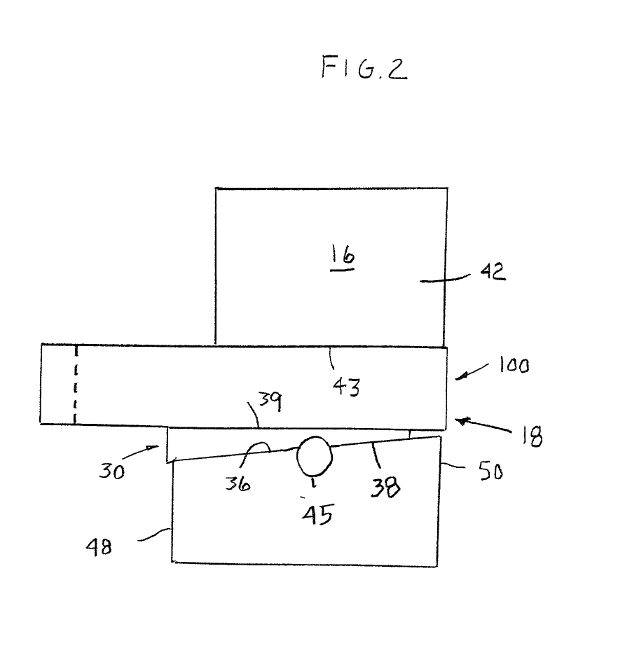

As better seen in FIG. 2, the tool mounting channel 18 has a tapered side 36 which slopes inwards from top 48 to bottom 50 of the block 16. The slope of tapered side 36 is preferably about 50, though any suitable slope may be used. The remaining sides of the tool mounting channel 18 are substantially flat. A shim retainer 45 is also mounted on the front end 42 and is further described below.

In the preferred embodiment, as seen in FIG. 1, a removable spacer 40 is located against a bottom 41 of the channel 18 (see FIG. 1). The removable spacer 40 is preferably a plate member of suitable metal having a thickness of about 0.25″, though the spacer 40 may have any suitable thickness that is determined necessary to provide a solid foundation to the tool 100 against the bottom 41 of the channel 18. The spacer 40 is sized to offset the shank 102 a predetermined amount from the bottom 41 of the tool mounting channel 18. The width of spacer 40, in the direction of arrow F, is sufficiently smaller than the width of the tool mounting channel 18 to allow the adjustable shim 30 to be placed in the channel 18 alongside the spacer 40 (see FIG. 1). Although the adjustable shim 30 does not directly contact the spacer 40.

As seen in FIG. 1 and FIG. 2, the adjustable shim 30 has a general wedge shape. The adjustable shim 30 is made of suitable metal to allow the shim to slide up and down within the channel without galling the tool holder or the shim. The shim 30 has an inner side 39, and an outer side 38. The outer side 38 is sloped to complement the slope of tapered side 36 of the mounting channel 18 in the tool holder 10. The inner side 39 is substantially flat. Accordingly, when the shim 30 is inserted into the mating channel 18, outer side 38 is seated on tapered side 36 of the channel so that the slopes complement each other. The inner side 39 is substantially flat and generally parallel to the opposite side of the channel.

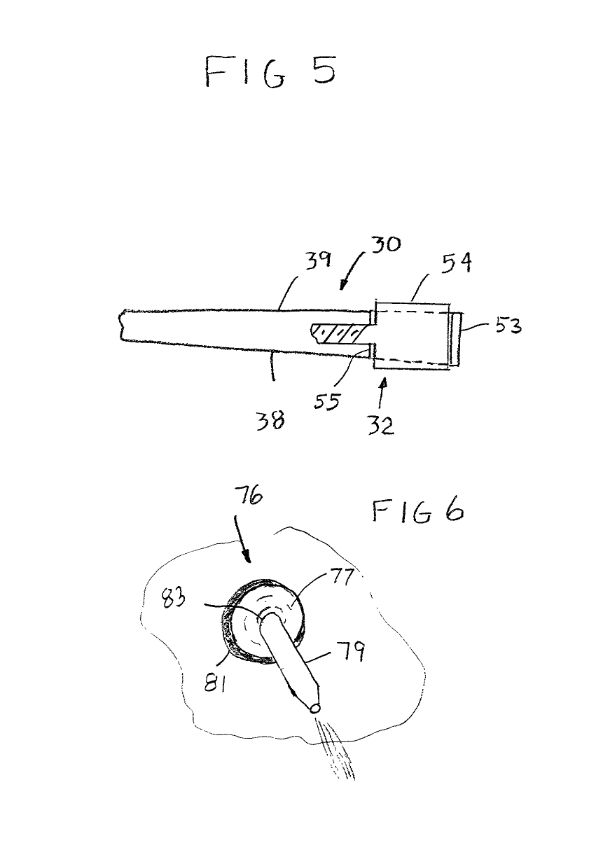

The mounting block 16 has a hole 34 in the top 48 for a shim adjusting fastener 32. Fastener 32 is threaded into the threaded portion of the hole 34. In greater detail, FIG. 5 illustrates one embodiment of an engagement of the shim adjusting fastener 32 to the adjustable shim 30. When the fastener 32 is located in the hole 34, a portion of the head 54 of fastener 32 enters through an opening 56 into the channel 18. The adjustable shim 30 has a scalloped section 52 therein with a top lip 53 and a bottom lip 55 which conform and confine the portion of the head 54 in the channel 18. When the shim 30 is located in the channel 18, the portion of the head 54 of fastener 32 enters into the scalloped section 52, behind the head 54 in FIG. 5, between the top and bottom lips 53 and 55, respectively. Thus engaged, when the fastener 32 is threaded into, and out of the hole 34, the adjustable shim 30 is moved vertically up and down in the channel 18 of the tool holder 10 (in the direction as indicated by arrow E). The vertical movement of the shim 30 caused by threading the shim adjusting screw 32 in/out of block 16, is translated by the cooperating tapered surfaces 36, 38 of the channel 18 and shim 30 into sideways movement of the inner side 39 of the shim as indicated by arrow F in FIG. 1. This in turn changes the position of the tool 100 (in the direction of arrow F) when installing the tool 100 in the tool holding channel 18. The shim retainer 45 abuts against a side 47 of the adjustable shim 30 so that the shim 30 remains engaged with the head 54 of the shim adjusting screw 32 as the shim 30 is moved either in or out. This provides for the positive engagement of the tool 100 between the tapered side 36 and a side 43 of the block 16. The lateral position of the tool 100 is adjusted in order to properly align the cutting edge 106 of the tool with the centerline axis CL of the spindle 212.

Referring also to FIG. 3, the tool holder 10 includes a coolant or lubrication passage 70 formed therein. In the preferred embodiment, the passage 70 generally includes a series of channels bored through the base 14 and block 16 of the tool 10 connecting an inlet 74 in the base 20 to an outlet port 76 in the top 48 of the block 16. The inlet port 74 in the base 14 mates with a coolant source outlet 75 or boss (see FIG. 4) on the turret face 202 when the tool holder is mounted to the turret face 202. As shown in FIG. 1, a flexible tube 72 may be connected to the outlet port 76 of the built-in coolant passage 70 in the tool holder 10. The flexible tube 72 may be flexibly adjusted to deliver internal coolant of the CNC machine tool directly to the cutting edge 106 of the tool 100 previously adjusted in the tool holder 10 during machining operations. Another embodiment of the coolant outlet port 76 is shown in FIG. 6 where a rotatable ball 77 is mounted in an opening 81. A nozzle 79 is connected into a coolant channel 83 of the ball 77. The liquid coolant under pressure is input into a back opening (not shown) in the ball 77 and flows through the coolant channel 83 of the ball 77 to the nozzle 79. The ball 77 is sealed within the coolant channel 83 and is rotatable therein so that the direction of the nozzle 79 may be adjusted to directly impact on the cutting edges 106.

It should be understood that the foregoing description is only illustrative of the invention. Various alternatives and modifications can be devised by those skilled in the art without departing from the invention. For example, various mounting features may be changed as desired to allow use of the tool holder on different machine tools. These holders may be used on the M Series of Citizen Machines. These models are M12, M16, M220 and M32. These machines have a coolant access hole that brings coolant to the face of the turret. In addition, tool holders may be provided with two mating holes on each end of the underside of the base of the holder which when mounted to the turret allows coolant to flow from the coolant access hole on the face of the turret into the tool holder to the tip of the cutting tool. The holder can be used for front and back turning operations. The tool holder allows for mating with the coolant access hole on the turret for either front or back turning operations. Accordingly, the present invention is intended to embrace all such alternatives, modifications and variances which fall within the scope of the appended claims.

What is claimed is:

1. A material removal tool holder for a machine tool, the holder comprising:
a frame with a tool holding channel formed therein for holding a material removal tool;
fasteners connected to the frame for holding the material removal tool in the tool holding channel of the frame; and
an adjustable shim mounted to the frame, the adjustable shim being disposed in the tool holding channel between the material removal tool and a wall of the channel, and being adjustable to position a cutting edge of the material removal tool to a predetermined position in the machine tool.

2. A material removal tool holder in accordance with claim 1 wherein the frame of the tool holder is adapted for use on a turret of a turret lathe.

3. A material removal tool holder in accordance with claim 2 wherein the turret lathe is an automatic turret lathe being computer controlled.

4. A material removal tool holder in accordance with claim 1 further including coolant passages within the frame of the tool holder, the coolant passages being in communication with a coolant source of a lathe when the tool holder is attached to the turret.

5. A material removal tool holder in accordance with claim 4 further including an outlet port for coolant fluid on the frame operably connected to the coolant passages for directing a flow of the coolant fluid onto the cutting edge of the material removal tool.

6. A material removal tool holder in accordance with claim 1 further including a spacer, the spacer being located in the channel, the material removal tool seated against the spacer when the material removal tool is mounted to the frame by the fasteners.

7. A material removal tool holder in accordance with claim 1 wherein the channel of the frame further comprises a tapered side upon which the adjustable shim is slidingly engaged.

8. A material removal tool holder in accordance with claim 7 further including an adjustable device mounted in the frame for adjusting the position of the adjustable shim within the channel of the tool holder.

9. A material removal tool holder in accordance with claim 1 wherein the adjustable shim is a wedge-shaped shim.

10. A material removal tool holder in accordance with claim 9 wherein the wedge-shaped shim has an outer side and an inner side, the outer side being tapered to complement a surface of the channel of the tool holder, the inner side being substantially parallel to a side of the channel against which the fasteners hold the removal tool.

11. A material removal tool holder in accordance with claim 10 wherein the wedge-shaped shim further includes a scalloped section for engagement with the adjustable device to move the shim in the channel.

12. A method for removing material from a work piece by a material removal tool held in a tool holder, the method comprises the step of:
adjusting a position of a material removal tool within a channel of the tool holder to align a cutting edge of the material removal tool with the work piece, an adjustable device being mounted within the tool holder for adjusting the position.

13. A method in accordance with claim 12 wherein the tool holder is mounted on a turret of a lathe and the work piece is mounted on a spindle, the removal tool being positioned to remove material from the work piece as the spindle rotates.

14. A method in accordance with claim 12 further including the step of cooling the tool holder and the removal tool mounted therein.

15. A method in accordance with claim 14 further including a step of cooling a cutting edge of the removal tool by adjusting a coolant outlet port, the coolant being provided by a coolant source to the tool holder.

16. A method in accordance with claim 12 wherein the tool holder further comprises an adjustable shim for positioning the removal tool within the channel of the tool holder for engagement with the work piece.

17. A kit comprising:
a machine tool tool holder having:
a frame with a tool holding channel for holding a tool in the frame;
fasteners for connecting the tool to the frame; and
an adjustable assembly in the frame for adjusting the tool in the frame.

18. A kit in accordance with claim 17 wherein the adjustable assembly comprises an adjustable shim mounted to the frame, the adjustable shim being disposed in the channel between the tool and a wall of the channel, and being adjustable to position a cutting edge of the tool to a predetermined position in the machine tool.

19. A kit in accordance with claim 17 wherein the frame has at least one integral coolant passage for directing a fluid to the tool.

20. A kit in accordance with claim 19 further comprising a flexible tube adapted to be connected to the frame for directing fluid from the at least one coolant passage to a working edge of the tool.
